(19) United States
(12) Patent Application Publication
(10) Pub. No.: US 2007/0294721 A1
(43) Pub. Date: Dec. 20, 2007

(54) System and method of providing supplemental video content related to targeted advertisements in a video stream

(75) Inventors: Anthony A. Haeuser, Aurora, IL (US); Mary McCarthy, San Antonio, TX (US); Scott A. Pettit, San Antonio, TX (US); Christopher Lee, Lakewood, CO (US); Roland Noll, San Antonio, TX (US); Scott White, Austin, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/471,429

(22) Filed: Jun. 20, 2006

(51) Int. Cl. H04N 5/445; H04N 7/10; G06F 13/00; H04N 7/025; G06F 3/00

(52) U.S. Cl. 725/34; 725/35; 725/46

(57) ABSTRACT

A method is provided that includes transmitting a video stream to a set-top box. The video stream may include a targeted advertisement with a user selectable indicator to identify supplemental video content related to the targeted advertisement based on a subscriber profile associated with the set-top box. The method further includes receiving a request from the set-top box based on the user selectable indicator and transmitting the supplemental video content to a memory of the set-top box independently from the video stream and without interrupting display of the video stream.

### FIELD OF THE DISCLOSURE

The present disclosure relates generally to systems and method of providing supplemental video content related to targeted advertisements in a video stream.

### BACKGROUND

Television networks typically support their programming by selling blocks of time to corporations for displaying commercials. Many advertisers use Nielsen ratings and available viewer demographic information to determine advertising placement. However, such ratings and demographic information represent a sampling of audiences. Thus, advertisers are likely to miss some interested viewers. Moreover, the same advertisement that is broadcast to all viewers may be inappropriate or incomplete relative to a subset of viewers.

Additionally, some corporations may have additional advertising information, which does not fit readily within a 30 to 60 second commercial block. However, interested viewers may want to view the additional advertising information, for example, when a particular product or commercial catches the viewers' attention. Hence, there is a need for a system and method of facilitating delivery of targeted advertising information to interested viewers.

### BRIEF DESCRIPTION OF THE DRAWINGS

FIG. 1 is a block diagram of a particular illustrative embodiment of a system to provide a video stream including advertisements with triggers;

FIG. 2 is a flow diagram of a particular embodiment of a method of providing advertisements within a video stream including user selectable triggers and of providing supplemental advertising in response to selection of a user selectable trigger;

FIG. 3 is a block diagram of a particular embodiment of a video system to provide a targeted advertisement including a user selectable indicator;

FIG. 4 flow diagram of a particular embodiment of a method of providing a targeted advertisement including a user selectable indicator;

FIG. 5 is a block diagram of a particular illustrative embodiment of a system including a set-top box to receive a targeted advertisement including a user selectable indicator;

FIG. 6 is a flow diagram of a particular illustrative embodiment of a method of receiving a targeted advertisement including a user selectable indicator;

FIG. 7 is a flow diagram of a particular illustrative embodiment of a method of retrieving supplemental video content by a subscriber premises equipment device, such as a set-top box;

FIG. 8 is a block diagram of a particular illustrative embodiment of a set-top box that includes logic to provide a menu of stored video content; and

FIG. 9 is a diagram of an illustrative embodiment of a general computer system.

### DETAILED DESCRIPTION OF THE DRAWINGS

In general, a particular illustrative embodiment, a method is provided that includes transmitting a video stream to a set-top box. The video stream may include a targeted advertisement with a user selectable indicator to identify supplemental video content related to the targeted advertisement based on a subscriber profile associated with the set-top box. The method further includes receiving a request from the set-top box based on the user selectable indicator and transmitting the supplemental video content to a memory of the set-top box independently from the video stream and without interrupting display of the video stream.

In one particular illustrative embodiment, a system includes selection logic, insertion logic, and a transmission interface. The selection logic selects a targeted advertisement including a user selectable indicator based on a subscriber profile associated with a set-top box, where the user selectable indicator identifies supplemental video content related to the targeted advertisement. The insertion logic inserts the targeted advertisement into a video stream at pre-determined advertising insertion points. The transmission interface transmits the video stream with the targeted advertisement to the set-top box. The transmission interface is responsive to a network to receive a selection related to the user selectable indicator and to transmit the supplemental video content to a memory of the set-top box independently of the video stream and without interrupting display of the video stream.

In yet another particular embodiment, an illustrative method is provided that includes receiving a video stream including a targeted advertisement having a user selectable indicator at a set-top box device from a network, where the user selectable indicator identifies supplemental video content related to the targeted advertisement. The method further includes providing the video stream to a display device, receiving an input related to the user selectable indicator at the set-top box, and retrieving and storing the supplemental video content in a memory of the set-top box without interrupting the video stream to the display device.

In still another particular illustrative embodiment, a set-top box includes an interface to receive a video stream including an advertisement having a user selectable indicator. The user selectable indicator identifies supplemental video content related to the advertisement. The set-top box further includes an output to provide the video stream to a display device, an input to receive user selections, a memory, and logic. The logic is responsive to the input to identify a user selection related to the user selectable indicator, to generate a request to a network via the interface in response to identification of the user selection, and to retrieve and store the supplemental video content in the memory without interrupting the video stream to the display device.

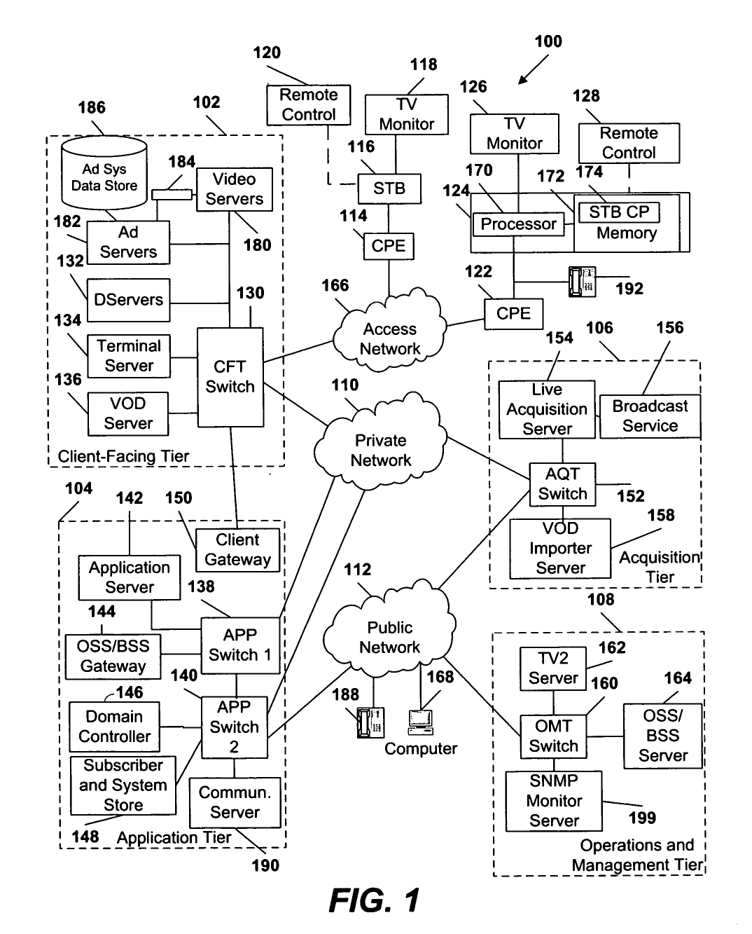

FIG. 1 is a block diagram of a particular illustrative embodiment of a system 100 to provide a video stream including advertisements with triggers. As shown, the system 100 includes a client facing tier 102, an application tier 104, an acquisition tier 106, and an operations and management tier 108. Each tier 102, 104, 106, 108 is coupled to a private network 110, to a public network 112 (such as the Internet), or to both the private network 110 and the public network 112. For example, the client-facing tier 102 can be coupled to the private network 110. The application tier 104 and the acquisition tier 106 may be coupled to the private network 110 and to the public network 112. The operations and management tier 108 may be coupled to the public network 112. Additionally, the client-facing tier 102 may be coupled to one or more customer premises equipment (CPE) 114 and 122 via an access network 166. The CPEs 114 and 122 may be coupled to a set-top box (STB) 116 and 124, respectively.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

The client-facing tier 102 is adapted to communicate with user equipment via an access network 166, such as an Internet Protocol Television (IPTV) access network. In an illustrative embodiment, customer premises equipment (CPE) 114, 122 may be coupled to a local switch or router of the access network 166. The client-facing tier 102 can communicate with a first representative set-top box device 116 at a first customer premise via the first CPE 114 and with a second representative set-top box device 124 at a second customer premise via the second CPE 122. The CPE 114, 122 can include routers, local area network devices, modems, such as digital subscriber line (DSL) modems, any other suitable devices for facilitating communication between a set-top box device and the access network 166, or any combination thereof.

In a particular embodiment, the client-facing tier 102 can be coupled to the CPE 114, 122 via fiber optic cables. Alternatively, the CPE 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

Additionally, the first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device 124 can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data, video, or any combination thereof, from the client-facing tier 102 via the private access network 166 and render or display the data, video, or any combination thereof, at the display device 118, 126 to which it is coupled. In an illustrative embodiment, the set-top box devices 116, 124 can include tuners that receive and decode television programming signals or packet streams for transmission to the display devices 118, 126. Further, the set-top box devices 116, 124 can include a STB processor 170 and a STB memory device 172 that is accessible to the STB processor 170. In one embodiment, a computer program, such as the STB computer program 174, can be embedded within the STB memory device 172.

In an illustrative embodiment, the client-facing tier 102 can include a client-facing tier (CFT) switch 130 that manages communication between the client-facing tier 102 and the access network 166 and between the client-facing tier 102 and the private network 110. As illustrated, the CFT switch 130 is coupled to one or more data servers, such as D-servers 132, that store, format, encode, replicate, or otherwise manipulate or prepare video content for communication from the client-facing tier 102 to the set-top box devices 116, 124. The CFT switch 130 can also be coupled to a terminal server 134 that provides terminal devices with a connection point to the private network 110. In a particular embodiment, the CFT switch 130 can be coupled to a video-on-demand (VOD) server 136 that stores or provides VOD content imported by the IPTV system 100.

Further, the CFT switch 130 is coupled to one or more video servers 180 that receive video content and transmit the content to the access network 166 via the CFT switch 130. In a particular embodiment, the CFT switch 130 can be coupled to one or more advertisement servers 182 that store advertisements. In an illustrative, non-limiting embodiment, the advertisement server(s) 182 can be coupled to the video server(s) via a splicer 184. In addition, the advertisement server(s) 182 can be coupled to one or more advertising system data stores 186 that store intended target criteria and other information related to the advertisements stored at the advertisement server(s) 182. Moreover, the advertising system data store(s) 186 can store subscriber profiles associated with the set-top box devices 116, 124.

In an illustrative embodiment, the client-facing tier 102 can communicate with a large number of set-top boxes, such as the representative set-top boxes 116, 124 over a wide geographic area, such as a regional area, a metropolitan area, a viewing area, a designated market area or any other suitable geographic area, market area, or subscriber or subscriber group that can be supported by networking the client-facing tier 102 to numerous set-top box devices. In a particular embodiment, the client-facing switch 130, or any portion thereof, can be a multicast router or switch that feeds one or more video streams from a video server to multiple set-top box devices.

The application tier 104 can include a first application tier (APP) switch 138, a second APP switch 140, an application server 142, an operation systems and support (OSS)/billing systems and support (BSS) gateway 144, a subscriber and system store 148, a client gateway 150, and a communications server 190. In a particular embodiment, the first APP switch 138 can be coupled to the second APP switch 140, to the application server 142, and to the OSS/BSS gateway 144. In a particular embodiment, the application server 142 provides applications to the set-top box devices 116 and 124 via the access network 166 to enable the set-top box devices 116 and 124 to provide various functions, including display functions, messaging functions, video processing functions, or any combination thereof. In one particular embodiment, the OSS/BSS gateway 144 can provide or restrict access to an OSS/BSS server 164 of the operations and management tier 108 that stores operations and billing systems data.

The second APP switch 140 may be coupled to a domain controller 146 that provides Internet access, for example, to users at their computers 168 via the public network 112. For example, the domain controller 146 can provide remote Internet access to IPTV account information, e-mail, personalized Internet services, or other online services via the public network 112. In addition, the second APP switch 140 can be coupled to a subscriber and system store 148 that includes account information, such as account information that is associated with users who access the system 100 via the private network 110 or the public network 112. In an illustrative embodiment, in addition to storing subscriber account information, the subscriber and system store 148 may create a subscriber profile associated with the IP address of a corresponding set-top box device, such as the set-top box devices 116 and 124.

In another illustrative embodiment, the second APP switch 140 may be coupled to one or more communication servers 190 that can connect calls from user telephones 188 and 192 with source or destination devices via the access network 166, the public network 112, a public switched telephone network (PSTN), another telephone network, or any combination thereof. In a particular embodiment, the communication server(s) 190 can collect telephone call history data, such as locations from which a subscriber has received calls, locations to which a subscriber has placed calls, or any combination thereof. The communication server(s) can store the telephone call history data and send it to the subscriber and system store 148, a data store (not shown) of the access network 166, another device within the IPTV system 100, or any combination thereof.

The client gateway 150 communicates data directly to the client-facing tier 102. In this particular embodiment, the client gateway 150 may be coupled directly to the CFT switch 130 to provide user access to the private network 110 and the tiers 106 and 108 coupled thereto. In an illustrative embodiment, the set-top box devices 116 and 124 can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the client-facing tier 102 via the access network 166, the client gateway 150 can verify subscriber information by communicating with the subscriber and system store 148 via the private network 110. Further, the client gateway 150 can verify billing information and status by communicating with the OSS/BSS gateway 144 via the private network 110. In one embodiment, the OSS/BSS gateway 144 can transmit a query via the public network 112 to the OSS/BSS server 164 to confirm subscriber and/or billing information. After the client gateway 150 confirms subscriber and/or billing information, the client gateway 150 can allow the set-top box device 116 to access IPTV content and video-on-demand (VOD) content at the client-facing tier 102. If the client gateway 150 cannot verify subscriber information for the set-top box device 116, (for example, because it is connected to an unauthorized twisted pair) the client gateway 150 can block transmissions to and from the set-top box device 116 beyond the access network 166.

As indicated in FIG. 1, the acquisition tier 106 includes an acquisition tier (AQT) switch 152, a live acquisition server 154, a broadcast service 156, and a VOD importer server 158. The AQT switch may communicate with the private network 110 and with the operations and management tier 108 via the public network 112. In a particular embodiment, the AQT switch 152 can be coupled to the live acquisition server 154, which receives or acquires television or movie content, for example, from the broadcast service 156, such as a satellite acquisition system or satellite head-end office. In a particular embodiment, the live acquisition server 154 can transmit the television or movie content to the AQT switch 152, and the AQT switch 152 can transmit the television or movie content to the CFT switch 130 via the private network 110.

In an illustrative embodiment, the television or movie content can be transmitted to the D-servers 132, where it can be encoded, formatted, stored, replicated, or otherwise manipulated and prepared for communication from the video server(s) 180 to the set-top box devices 116 and 124. The CFT switch 130 can receive the television or movie content from the video server(s) 180 and communicate the content to the CPE 114 and 122 via the access network 166. The set-top box devices 116 and 124 can receive the television or movie content via the CPE 114 and 122, and can transmit the television or movie content to the television monitors 118 and 126. In an illustrative embodiment, video or audio portions of the television or movie content can be streamed to the set-top box devices 116 and 124.

Further, the AQT switch 152 can be coupled to a video-on-demand importer server 158 that receives and stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116 and 124, the requests can be transmitted over the access network 166 to the VOD server 136, via the CFT switch 130. Upon receiving such requests, the VOD server 136 can retrieve the requested VOD content and transmit the content to the set-top box devices 116 and 124 across the access network 166, via the CFT switch 130. The set-top box devices 116 and 124 can transmit the VOD content to the television monitors 118 and 126. In an illustrative embodiment, video or audio portions of VOD content can be streamed to the set-top box devices 116 and 124.

FIG. 1 further illustrates a particular embodiment of the operations and management tier 108 that can include an operations and management tier (OMT) switch 160, a TV2 server 162, the OSS/BSS server 164, and a simple network management protocol (SNMP) monitor 199. The OMT switch 160 conducts communication between the operations and management tier 108 and the public network 112. The OMT switch 160 is coupled to the TV2 server 162. Additionally, the OMT switch 160 can be coupled to the OSS/BSS server 164 and to the simple network management protocol (SNMP) monitor 199 that monitors network devices within or coupled to the IPTV system 100. In a particular embodiment, the OMT switch 160 can communicate with the AQT switch 152 via the public network 112.

In operation, the live acquisition server 154 can transmit the television or movie content to the AQT switch 152, and the AQT switch 152, in turn, can transmit the television or movie content to the OMT switch 160 via the public network 112. In this embodiment, the OMT switch 160 can transmit the television or movie content to the TV2 server 162 for display to users accessing the user interface at the TV2 server 162. For example, in one particular embodiment, a user can access the TV2 server 162 using a personal computer (PC) coupled to the public network 112.

In a particular illustrative embodiment, subscriber information associated with the set-top box devices 116 and 124 can be stored at a data store coupled to a local switch of the access network 166. For example, the subscriber information associated with the set-top box devices 116 and 124 may be stored in a subscriber and system store 148 of the application tier 104, which is coupled to the access network 166 via the private network 110 and the CFT switch 130. The subscriber information that is stored in the subscriber and system store 148 may include viewing habits of a user of the set-top box devices 116 and 124, demographic information associated with the subscriber (such as age, gender, marital status, and the like), the location information, accumulated survey information, or any combination thereof. Associated subscriber information may be associated with each of the set-top box devices 116 and 124.

In one particular embodiment, the subscriber information may include telephone call history data associated with subscribers or users of the set-top box devices 116 and 124. In another particular embodiment, the subscriber information may include Internet viewing habits associated with subscribers or users of the set-top box devices 116 and 124. Additionally, the set-top box devices 116 and 124 may provide other information related to preferences or interests associated with subscribers or users, based on user selections of available options provided by the set-top boxes 116 and 124, based on user-provided information, based on usage information, and the like. In a particular embodiment, the data store can receive and store subscriber information related to a subscriber's telephone call history data from the communication server(s) 190, a subscriber's subscription profile from a subscriber and system store 148, or subscriber data derived from another server of the IPTV system 100.

In another particular embodiment, at least a portion of the subscriber information, such as television viewing habits, can be collected at the local switch. In another particular embodiment, demographic information, such as broadcast television ratings information, including age-related demographic information, may be collected by a third-party and accessed by the subscriber and system store 148 to supplement the subscriber information. In still another particular embodiment, a third-party may collect demographic information and other subscriber-related information and provide it to the subscriber and system store 148.

In an illustrative embodiment, subscriber information stored in a data store at the access network 166 or stored in the subscriber and system store 148 of the application tier 104 may be used to develop subscriber profiles that are associated with IP addresses of various set-top box devices. For example, a first subscriber profile associated with the first representative set-top box device 116 can be associated with an IP address of the first representative set-top box device 116, and a second subscriber profile associated with the second representative set-top box device 124 can be associated with an IP address of the second representative set-top box device 124. The subscriber profiles and associated IP addresses can be sent from the access network 166 to the advertising system data store(s) 186 at the client-facing tier 102.

In an illustrative embodiment, advertisements can be received at the acquisition tier 106, for example, via the broadcast service 156. Such advertisements are sent to the advertisement server(s) 182 and stored. The advertising system data store(s) 186 can store information associated with advertisements stored at the advertisement server(s) 182, such as advertisement identifiers, advertisement lengths, advertisement subject matter, advertiser name, product name, profiles of intended advertisement targets, other information related to advertisements stored at the advertisement server(s) 182, or any combination thereof. Additionally, a particular advertisement may include a user selectable element, such as a selectable icon, a trigger, or another element, which can be provided within the broadcast and which can be selected by a subscriber from the video stream using, for example, a remote control. The user selectable element may be associated with a supplemental advertising content stored, for example, within the VOD server 136.

Further, the advertising system data store(s) 186 can store information related to advertisements stored at the advertisement server(s) 182. For example, the advertising system data store(s) 186 can store an identifier of each one of the advertisements stored at the advertisement server(s) 182. In addition, the advertising system data store(s) 186 can store intended target information related to each one of the advertisements stored at the advertisement server(s) 182, which can be compared to subscriber profiles of the subscriber and system store 148 to target advertisements to a particular set-top box according to the associated subscriber profile. Intended target information can include intended target demographic information associated with each advertisement. The particular targeted advertisement may include a user selectable element, such as a trigger, an icon or other element within the video stream, which may be associated with supplemental video content accessible via the VOD server 136, via the advertising system data store 186, via the ad servers 182, or any combination thereof.

For example, a travel advertisement for a trip to Scotland could be targeted to multiple intended targets that include subscribers that place calls to, or receive calls from, Scotland; subscribers that frequently watch golfing events; subscribers that frequently surf the Internet for travel packages; and other intended targets. In this instance, the targeted advertisement may include a user selectable element, which a subscriber may select to view additional information related to the travel advertisement. For example, a 30-second advertising spot may provide only cursory information related to a travel package. However, the user selectable element contained within the 30-second advertising spot may be utilized to retrieve supplemental video content for later viewing.

In another example, a targeted advertisement may be inserted into the video stream that includes local data associated with the advertiser. For example, if a company is opening a new branch in a particular town, the targeted advertisement may be inserted into the video stream for set-top boxes in the locality of the new branch, including user selectable triggers for the user to retrieve supplemental video content associated with the branch. In this instance, the supplemental video content may include special offers and incentives available only through the new branch.

In a particular embodiment, the video server(s) 180 transmits video streams to the set-top box devices 116, 124. The video server(s) 180 can recognize advertisement insertion points, which may include cue tones or other cues, in a video stream before or coinciding with positions where advertisements are to be inserted into the video stream. Upon recognizing an advertisement insertion point, the video server(s) 180 can issue a request to the advertisement server(s) 182 to receive one or more advertisements. For instance, the video server(s) 180 can issue a request to the advertisement server(s) 182 for a first advertisement to be inserted into a first video stream being sent to the IP address of the first representative set-top box device 116, and a second advertisement to be inserted into a second video stream being sent to the EP address of the second representative set-top box device 124. Each request can include an IP address or other identifier of the set-top box device to which a requested advertisement is to be sent.

The advertisement server(s) 182 can select the first advertisement based on the subscriber profile associated with the IP address of the first representative set-top box device 116 at the advertising system data store(s) 186, and the second advertisement based on the subscriber profile associated with the IP address of the second representative set-top box device 124 at the advertising system data store(s) 186. In an illustrative embodiment, the advertisement server(s) 182 can issue a query to the advertising system data store(s) 186 to receive a recommendation or selection of a targeted advertisement to be sent to a set-top box device identified in a request from the video server(s) 180. The advertising system data store(s) 186 can compare a subscriber profile associated with the selected set-top box device to intended target information related to advertisements stored at the advertisement server(s) 182. The advertising system data store(s) 186 can send a recommendation or selection of a targeted advertisement to be sent to the set-top box device to the advertisement server(s) 182, where the subscriber profile associated with the set-top box device at least partially matches intended advertisement target information associated with the targeted advertisement. The advertisement server(s) 182 can select an advertisement based on the recommendation or selection received from the advertising system data store(s) 186 and send video data of the selected advertisement to the video server(s) 180.

The video server(s) 180 inserts the video data of the selected advertisement(s) into the video streams being sent to the corresponding set-top box devices 116, 124. In an illustrative, non-limiting embodiment, the advertisement server(s) 182 can transmit the selected advertisement(s) to the video server(s) 180 via the splicer 184, and the splicer 184 can splice the video data of the selected advertisement(s) into the video stream being sent by the video server (s) 180. Each advertisement is placed into a video stream being sent to one or more IP addresses, each of which is associated with a subscriber profile that at least partially matches an intended advertisement target. The video stream is dispatched to the IP addresses via the access network 166.

In a particular embodiment, the local switch of the access network 166 can determine and record whether the set-top box device of an intended advertisement target is tuned to a network on which a targeted advertisement is shown during the targeted advertisement or during a portion of the targeted advertisement. Such ad viewership information can be stored at the access network 166 and can be used to update subscriber profiles. Aggregated viewership information, non-aggregated viewership information, updated profiles, or any combination thereof, can be sent from the access network 166 to the advertising system data store(s) 186.

In operation, the system may transmit a video stream including a selected advertisement including a user selectable indicator, such as a popup alert, a selectable image or icon within the advertisement, a user selectable element, a user selectable trigger, or another indicator, which appears on the display device as part of the advertising content and which the user may select using an input device, such as a remote control. The user selectable indicator is associated with supplemental video content that is related to the selected advertisement

In one particular embodiment, the set-top box, such as set-top box 116 may receive a user selection and transmit the user selection to a server, such as a video-on-demand (VOD) server 136, to retrieve and store the supplemental video content related to the user selectable element in a memory of the set-top box 116, without interrupting display of the video stream. The supplemental video content may be downloaded and stored in the background. The supplemental video content may include details related to one or more travel packages and may be retrieved by a subscriber by accessing a digital video recorder (DVR) menu of the set-top box 116 to retrieve and view stored video content. The set-top box 116 include logic to generate a list of stored video content and to add an identifier associated with the supplemental video content to the list. The subscriber may then select the identifier from the list to view the supplemental video content. In one particular embodiment, the logic may organize the list of stored video content by retrieval date, for example.

In another particular embodiment, the user selection of the user selectable element may be transmitted to a server, and the server may store a list of user selected video content, such as a network-based DVR menu, which a subscriber may access at a later time to retrieve selected video content, including the supplemental video content.

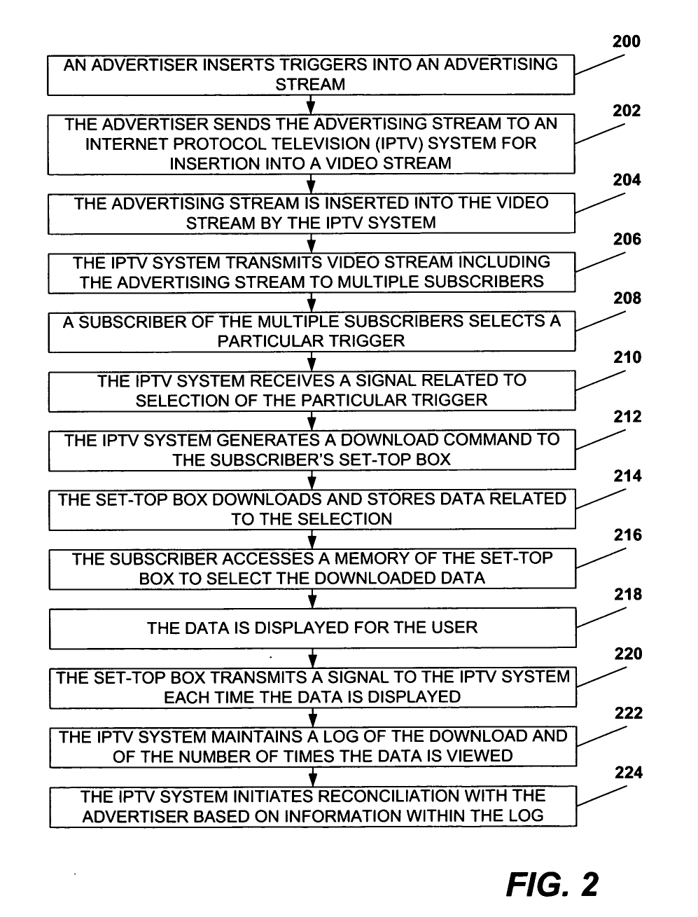

FIG. 2 is a flow diagram of a particular illustrative embodiment of a method of providing advertisements within a video stream including user selectable triggers and of providing supplemental advertising in response to selection of a user selectable trigger. An advertiser inserts one or more triggers into an advertising stream (block 200). The advertiser sends the advertising stream to an Internet protocol television (IPTV) system for insertion into a video stream (block 202). The advertising stream is inserted into a broadcast video stream by the IPTV system (block 204). The IPTV system transmits the video stream, including the advertising stream with the inserted triggers, to multiple subscribers (block 206). A subscriber of the multiple subscribers selects a particular trigger (block 208). The IPTV system receives a signal related to the selection of the particular trigger (block 210). The IPTV system generates a download command to the subscriber's set-top box (block 212). The set-top box downloads and stores data related to the selection (block 214). The subscriber accesses a memory of the set-top box to select the downloaded data (block 216). The data is displayed for the user by the set-top box (block 218). The set-top box transmits a signal to the IPTV system each time the data is displayed (block 220). The IPTV system maintains a log of the download and of the number of times the data is viewed (block 222). The IPTV system initiates reconciliation with the advertisers based on information contained within the log (block 224).

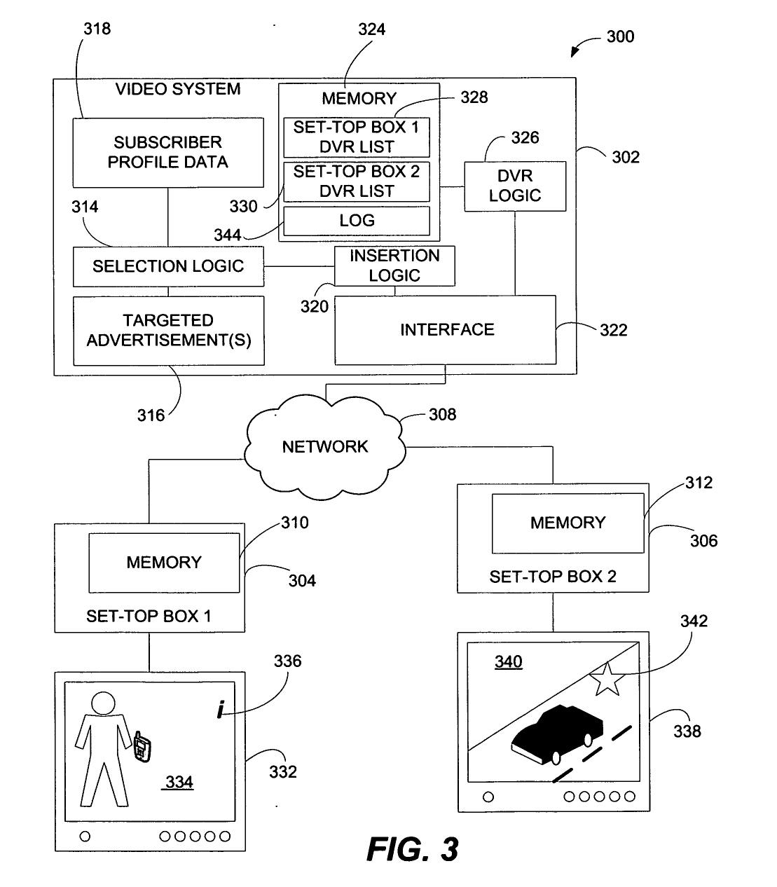

FIG. 3 is a block diagram of a particular illustrative embodiment of a system 300 to provide a targeted advertisement including a user selectable indicator. The system 300 includes a video system 302 coupled to a set-top box 304 and to a set-top box 306 via a network 308. The set-top box 304 (set-top box 1) may include a memory 310 and the set-top box 306 (set-top box 2) may also include a memory 312.

The video system 302 may include selection logic 314 coupled to a data store including one or more targeted advertisements 316 and to subscriber profile data 318. Additionally, the selection logic 314 is coupled to insertion logic 320. The insertion logic 320 may be coupled to an interface 322, which may in turn be coupled to the network 306. The video system 302 may also include a memory 324 and digital video recorder (DVR) logic 326. The memory 324 may store a set-top box 1 DVR list 328 and a set-top box 2 DVR list 330, which may be associated with the set-top box 304 and the set-top box 306, respectively.

The set-top box 304 may be coupled to a display device 332, which may display a targeted advertisement 334 that includes a user selectable element 336. The set-top box 306 may be coupled to a display device 338, which may display a different targeted advertisement 340 that includes a different user selectable element 342.

In operation, the selection logic 314 selects targeted advertisements from the targeted advertisements 316 for each set-top box 304 and 306 based on a subscriber profile associated with the particular set-top box that is stored in the subscriber profile data 318. Each of the selected targeted advertisements includes a user selectable indicator. The selected targeted advertisements may be different for each set-top box 304 and 306. The insertion logic 320 inserts the first targeted advertisement into a first video stream at a pre-determined advertising insertion point of a video stream directed to the set-top box 304 via the network 308. The insertion logic 320 inserts the second targeted advertisement into a second video stream at a pre-determined advertising insertion point. The insertion logic 320 provides the video streams with the targeted advertisements to the interface 322, which transmits the video streams with the inserted targeted advertisements to the selected set-top boxes 304 and 306 via the network 308. The set-top box 304 provides the first video stream to the display device 332, which displays an advertisement 334 including the user selectable indicator 336. The set-top box 306 provides the second video stream to the display device 38, which displays an advertisement 340 including the user selectable indicator 342.

A subscriber may select the user selectable indicator 336, for example. In one particular embodiment, a subscriber or user may select the user selectable indicator 336 using a remote control, for example. The set-top box 304 receives the input related to the selection of the user selectable indicator 336. The set-top box 304 transmits a signal to the video system 302 via the network 308. The interface 322 is responsive to the network 308 to receive the selection related to the user selectable indicator 336 and/or to receive a selection related to the user selectable indicator 342.

In one particular illustrative embodiment, the supplemental video content may be downloaded to the memory 310 of the set-top box 304 in the background while the video stream continues to be displayed on the display device 332 and without interrupting display of the video stream. Thus, the download of the supplemental video content need not disrupt normal viewing. Since the user selectable indicator 336 is embedded within the advertisement, even if the subscriber is recording the first video stream using a digital video recorder (DVR) function, the user selectable indicator 336 is stored together with the video stream. By including the user selectable indicator 336 in the first video stream, a subscriber may select the user selectable indicator, even when viewing a recorded version of the video stream, to retrieve the supplemental video content.

In general, it should be understood that the user selectable indicator, such as indicator 336, may appear on a display device 332 attached to the set-top box 304 during the targeted advertisement 316. In the particular illustrative embodiment shown, the display device 332 includes a display 334 on which an advertisement 316 including a user selectable indicator 336 is shown. The user selectable indicator 336 is shown as a stylized letter “i” to signify that additional information about the product is available. A customer may select the user selectable indicator 336, for instance, by pressing a select button on a remote control. The user selectable indicator 336 may be an icon associated with the product (such as a user selectable image of a telephone, a user selectable logo associated with the advertiser, and the like). In one particular embodiment, the user selectable indicator 336 may be outlined in a bright color to stand out from the background.

In another particular embodiment, the video system 302, upon receiving the selection related to the user selectable indicator 336, the DVR logic 326 may add an identifier related to the supplemental video content to the set-top box 1 DVR list 328 in the memory 324. The DVR lists 328 and 330 may include a list of video content selected via the set-top boxes 304 and 306, respectively. The memory 324 may store a plurality of DVR lists, where each DVR list is associated with a particular set-top box, using an IP address or another identifier to distinguish between the set-top boxes. The video system 302 provides a DVR menu including the set-top box 1 DVR list 328 to the set-top box 304 in response to a request from the set-top box 304, for example. A subscriber may select the supplemental video content using the DVR menu, and the supplemental video content is retrieved and is transmitted via interface 322 to the set-top box 304.

Additionally, the video system 302 may store a log 344 related to transmission of the supplemental video content in the memory 324. In another particular embodiment, the video system 300 may utilize logic, such as the selection logic 314 (or other logic not shown) to adjust the subscriber profile associated with the selected set-top box 304 according to the selection. For example, if a subscriber associated with the set-top box 306 selects a user selectable indicator 342 associated with a particular targeted advertisement related to an automobile advertisement 340, the video system 302 may modify the subscriber profile of the set-top box 306 based on the selection to possibly target other automobile advertisements to the particular set-top box 306. The subscriber profile may include subscriber usage data associated with the set-top box 306. The subscriber profile may also include viewing habits, visited web sites, demographic data, subscriber account information (including a location associated with the subscriber account), subscriber supplied information, or any combination thereof. In another embodiment, the subscriber profile may be derived from third party information, such as census data, Neilson Ratings data, phone call data, and the like.

Generally, the video system 302 may transmit the supplemental video content to a memory 312 of the set-top box 306 in the background, such that the supplemental video content is transmitted to the set-top box 306 without interrupting display 340 of the video stream in the display device 338. The supplemental video content may then be accessed by the subscriber via a list stored in the memory 312. The list may be generated by logic within the set-top box. Alternatively, the supplemental video content may be accessed by the subscriber via the associated list 330 stored in the memory 324 of the video system 302. The subscriber may then access the DVR list 330 to retrieve and view the supplemental video content.

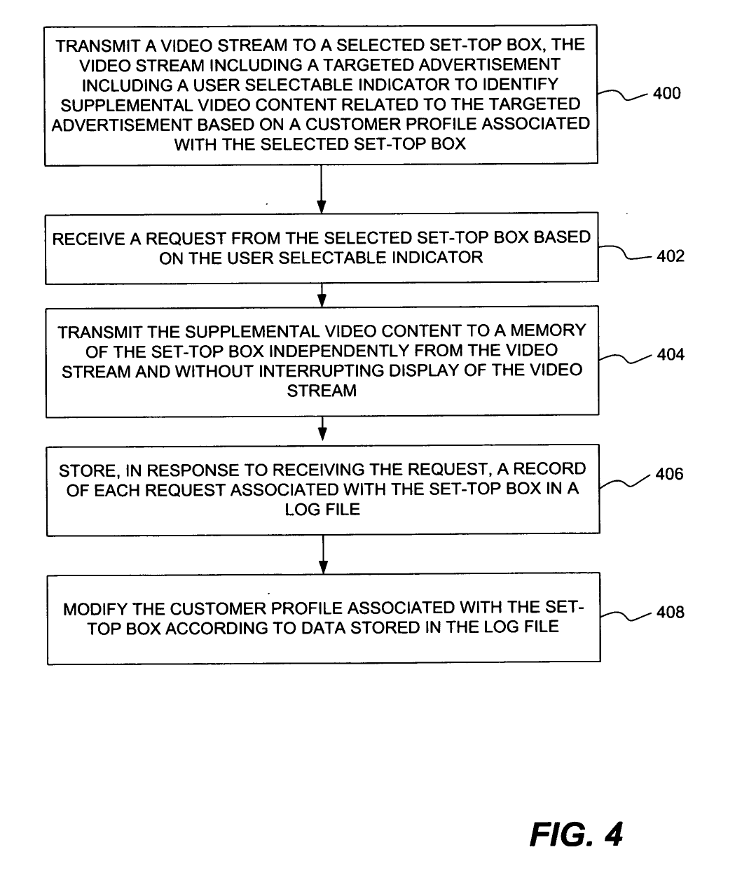

FIG. 4 illustrates a flow diagram of a particular embodiment of a method of providing a targeted advertisement including a user selectable indicator. A video stream is transmitted to a selected set-top box, where the video stream includes a targeted advertisement including a user selectable indicator to identify supplemental video content related to the targeted advertisement based on a subscriber profile associated with the selected set-top box (block 400). A request is received from the selected set-top box based on the user selectable indicator (block 402). The supplemental video content is transmitted to a memory of the set-top box independently from the video stream and without interrupting display of the video stream (block 404). A record of each request associated with the set-top box is stored in a log file (block 406). The customer profile of the set-top box is modified according to data stored in the log file (block 408).

In one particular embodiment, the supplemental video content may be transmitted to the set-top box concurrently with the video stream and without interrupting display of the video stream. In one embodiment, the supplemental video content may be transmitted in the background while the video stream is also being transmitted. In another particular embodiment, the supplemental video content is transmitted to the set-top box at a later time relative to transmitting the video stream. For example, if the network usage is high, it may be desirable to download the supplemental video content in off-peak hours, or after the current video stream is terminated. In another particular embodiment, the video server maintains a list of the selected supplemental video, as well as other digital video recorder selections, which a subscriber may access to select particular video content.

In one particular embodiment, the targeted advertisement is selected from a plurality of advertisements based on the subscriber profile, where the targeted advertisement includes a target profile that at least partially matches the subscriber profile. The plurality of advertisements may be stored in a database and retrieved based on the subscriber profile and based on an intended target for the particular advertisement. A subscriber profile may be created automatically from survey responses received from the subscriber, from account information associated with the subscriber, from credit information used to establish the subscriber account, and so on. The subscriber profile may be associated with an Internet Protocol (IP) address of a particular set-top box.

For example, if the subscriber profile (generated from the subscriber account information) indicates that the set-top box is associated with a male in an age range of 25-40, advertisements intended for the particular age group may be selected for transmission. Alternatively, if the subscriber profile indicates a location of the set-top box, such as San Antonio, Tex., advertisements that are relevant to the particular area or region may be selected for transmission. In one particular embodiment, the subscriber profile includes information derived from subscriber usage of the Internet, which may be accessed via the set-top box. In yet another particular embodiment, the subscriber profile may be derived from subscriber-provided data, such as data derived from responses to a survey. In still another embodiment, the subscriber profile data may be collected and provided by a third party, such as the government (census data), other companies (television ratings companies, telephone companies, Internet service providers, and the like), or any combination thereof. In one particular embodiment, the subscriber profile includes demographic data and subscriber usage data associated with the set-top box. In another particular embodiment, the subscriber profile includes subscriber account information and subscriber preference data.

In one particular embodiment, a login may be used to gain control access to a set-top box. For example, a particular login may deny access or may provide access to particular channels. The login information may be transmitted by the set-top box to the associated network, which may use the login to retrieve a subscriber profile associated with the particular login information. In this manner, targeted advertising may vary from subscriber to subscriber within a single household.

In another particular embodiment, an indication is received from the selected set-top box each time the supplemental video content is viewed. The indication may be stored in a log file and may be associated with the record of the associated request. The log file may include, for example, a date and a time of the download. Additionally, the log file may include data related to each viewing of the supplemental video content, such that each time a user accesses the supplemental video content from the memory of the set-top box, the log file may be updated to record an indication related to each viewing. In one particular embodiment, the set-top box may transmit data related to the system each time the supplemental video content is accessed by the user.

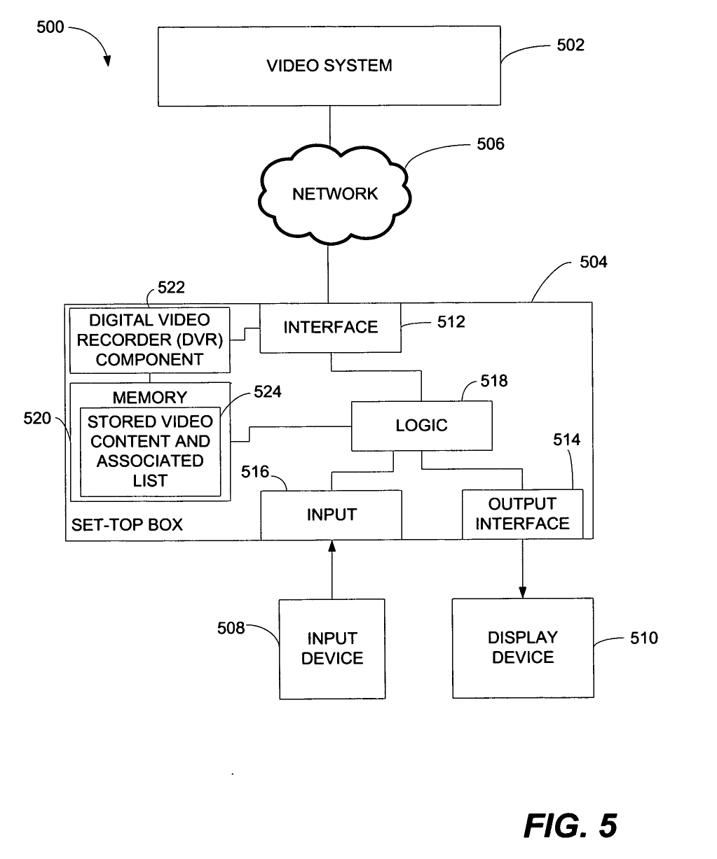

FIG. 5 is a block diagram of a particular illustrative embodiment of a system 500 including a set-top box to receive a targeted advertisement including a user selectable indicator. The system 500 includes a video system 502 coupled to a set-top box 504 via a network 506. The video system 502 is adapted to transmit a video stream including a targeted advertisement with a user selectable indicator. The video system 502 is also adapted to transmit supplemental video content to the set-top box 504 via the network 506 in response to receiving a selection related to the user selectable indicator. The video system 502 may transmit the supplemental video content to the memory 520 of the set-top box 504 independently from the video stream (e.g., in the background), such that display of the video stream to the display device 510 is not interrupted by the supplemental video content.

The set-top box 504 includes an input interface 512, an output interface 514, an input 516, logic 518, a memory 520, and a digital video recorder (DVR) component 522. The memory 520 may include stored video content and an associated list 524. The system 500 may also include an input device 508 coupled to the input 516. The input device 508 may include a remote control or other device to interact with the set-top box 504. The system 500 may also include a display device 510 coupled to the output interface 514. The display device 510 may be a television, a liquid crystal display (LCD) adapted to display a video signal, or another type of display device.

In operation, the input interface 512 receives a video stream including an advertisement having a user selectable indicator, where the user selectable indicator identifies supplemental video content related to the advertisement. The output interface 514 provides the video stream to the display device 510. The input 516 receives user selections. In one particular embodiment, the logic 518 is responsive to the input 516 to identify a user selection related to the user selectable indicator, to generate a request to a network interface via the interface 512 in response to identification of the user selection, and to retrieve and store the supplemental video content from the network 506 in the memory 520 via the input interface 512, without interrupting the display of the video stream to the display device 510. The logic 518 may store the supplemental video content in the memory 520 concurrently while the video stream is provided to the display device 510, so that the supplemental video content may be downloaded without interrupting the display. In another particular embodiment, the logic 518 may redirect the subscriber to an alternate channel on which the advertiser has purchased additional time.

The logic 518 may generate a list of stored video content for user selection of the supplemental video content. In one particular embodiment, the list may be organized by retrieval/storage date, in alphabetical order by title, in a custom order specified by the subscriber via the input device 508, or any combination thereof.

The video system 502 may be, for example, a video on demand (VOD) system, a broadcast system, or any combination thereof. The video system 502 may include advertising servers, VOD servers, subscriber interface servers, edge servers, and the like. In one particular embodiment, the video system 502 may provide a video stream via a network 506, such as a public switched network, the Internet, a broadcast network, or any combination thereof to a customer premises. The customer premises may include customer premises equipment, which provides the video stream to the set-top box 504 via a coaxial cable, for example. The set-top box 504 may provide a video output signal to the display device 510 via a coaxial cable, via video and audio input cables, or any combination thereof. The input interface 512 may be a coaxial connector, a broadband connection, an RJ-45 Ethernet interface, or another type of interface to receive audio and video signals. The output interface 514 may be a coaxial interface, an audio/video jack, or another type of interface to connect to a display device 510, such as a television.

In one particular embodiment, the logic 518 is adapted to provide a list of stored content to the display device 510, to identify a user selection to access the supplemental video content stored in the memory 520 based on an input from the input device 508, and to initiate retrieval and display of the supplemental video content from the memory 520. A user may access the supplemental video content via a menu function of the set-top box 504 using the input device 508. If a video stream is recorded using the DVR component 522, the stored video stream includes the advertisement with the user selectable indicator. In one particular embodiment, the advertisement may be a targeted advertisement that is targeted according to a subscriber profile associated with the set-top box 504, which may be maintained by the video system 502.

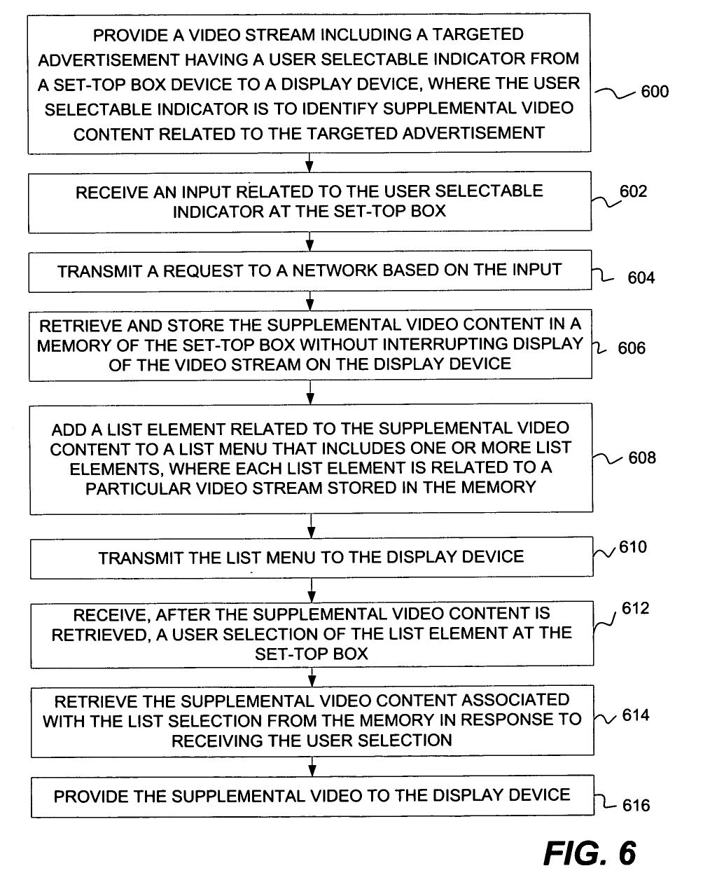

FIG. 6 is a flow diagram of a particular illustrative embodiment of a method of receiving a targeted advertisement including a user selectable indicator. A video stream is provided including a targeted advertisement having a user selectable indicator from a set-top box device to a display device, where the user selectable indicator identifies supplemental video content related to the targeted advertisement (block 600). An input is received that is related to the user selectable indicator at the set-top box (block 602). A request is transmitted to a network based on the input (block 604. The supplemental video content is retrieved and stored in a memory of the set-top box without interrupting display of the video stream on the display device (block 606). A list element related to the supplemental video content is added to a list menu that includes one or more list elements, where each list element is related to a particular video stream stored in the memory (block 608). The list menu is transmitted to the display device (block 610). A user selection is received, at a later time, to display the supplemental video (block 612). The supplemental video content associated with the list selection is retrieved from the memory in response to receiving the user selection (block 614). The supplemental video content is provided to the display device (block 616).

In another embodiment, the video stream may be provided by retrieving a digitally recorded version of the video stream from the memory and by outputting the retrieved digitally recorded version to the display device. The digitally recorded version may include the targeted advertisement with the user selectable indicator. In yet another embodiment, the video stream may be received from the network and may be output to the display device or recorded in the memory.

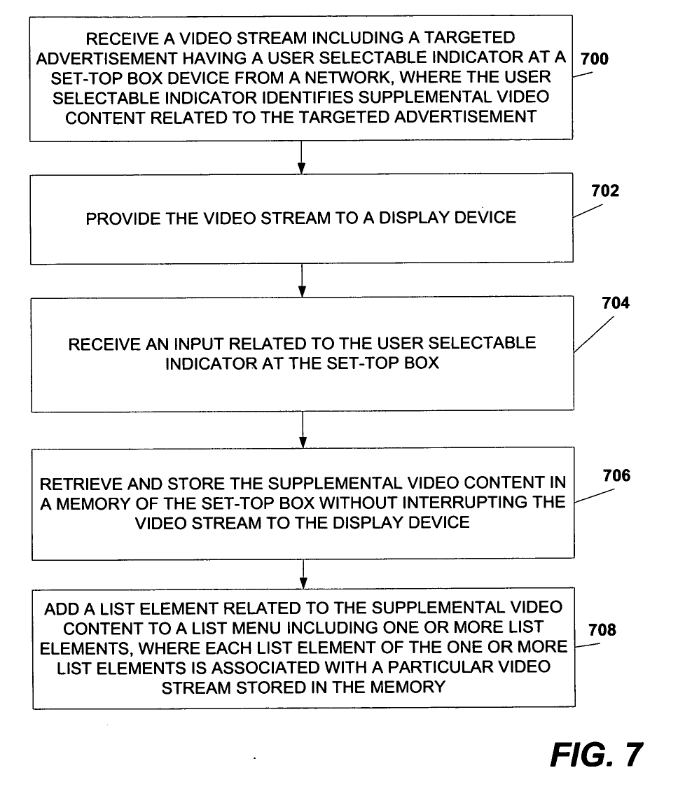

FIG. 7 is a flow diagram of a particular illustrative embodiment of an alternative method of retrieving supplemental video content by a customer premises equipment device from a Video on Demand (VOD) server. A video stream including a targeted advertisement having a user selectable indicator is received at a set-top box device from a network, where the user selectable indicator identifies supplemental video content related to the targeted advertisement (block 700). The video stream is provided to a display device (block 702). An input related to the user selectable indicator is received at the set-top box (block 704). The supplemental video content is retrieved and stored in a memory of the set-top box without interrupting the video stream to the display device (block 706). A list element related to the supplemental video content is added to a list menu including one or more list elements, where each list element of the one or more list elements is associated with a particular video stream stored in the memory (block 708).

In one particular illustrative embodiment, a list element that is related to the supplemental video content may be stored in a digital video recording (DVR) list associated with the set-top box in a memory of the set-top box or in a memory of a server for later retrieval. When the list is stored in a memory of the set-top box, logic of the set-top box may add an identifier associated with each download to a list of stored video content. The logic may organize the list based on a download/retrieval date, alphabetically according to title, in a custom order specified by a user, or any combination thereof.

In one particular illustrative embodiment, user selection of the user selectable indicator may direct the customer premises equipment (such as a set-top box device) to a different channel to receive the supplemental video content, while recording the video stream of the channel to which the set-top box was previously tuned. When the user is finished viewing the supplemental video content, the user may select the stored video stream and resume viewing.

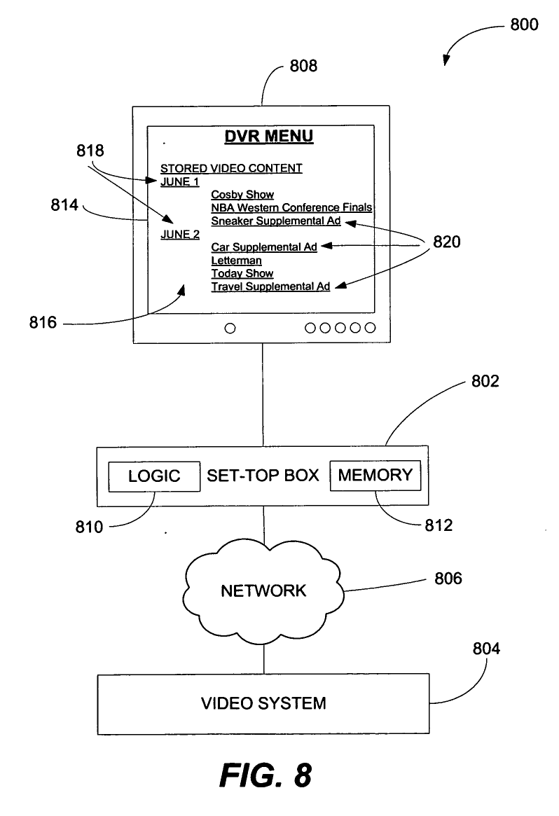

FIG. 8 is a block diagram of a particular illustrative embodiment of a system 800 including a set-top box 802 coupled to a video system 804 via a network 806. The system 800 also includes a display device 808, such as a television. The set-top box 802 includes logic 810 and a memory 812.

During operation, the set-top box 802 receives a video stream from the video system 804 via the network 806. The set-top box 802 provides the video stream to the display device 808 for display. In response to a user selection of a user selectable element within a targeted advertisement in the video stream, the set-top box 802 retrieves supplemental video content from the video system 804 and stores the supplemental video content in the memory 812. When video content is downloaded and stored in a memory 812 of the set-top box 802, the logic 810 adds an identifier to a list of stored video content. The identifier is related to the video content stored within the memory 812.

After the supplemental video content is downloaded, for example, a user may access the downloaded video content by accessing a menu of the set-top box 802. The logic 810 generates the menu and the set-top box 802 provides the menu to the display 808. The display device 808 includes a display 814 having a particular illustrative embodiment of a menu 816 generated by the logic 810. The menu 816 includes headings 818, which may be the download/retrieval date associated with the particular video content. The menu 816 includes supplemental video content 820, related to particular advertisements organized within the headings 818.

It should be understood that the logic 810 may generate the list within the menu 816 according to any number of organizational techniques, including date order, alphabetical order, user order, or another custom order specified by the user, for example. Additionally, the menu 816 may be generated by the logic 810 to show downloads associated with a particular user of the set-top box 802. Thus, if several user's are specified, the set-top box 802 may allow a user to select one or more menus and to choose a particular organization for each menu.

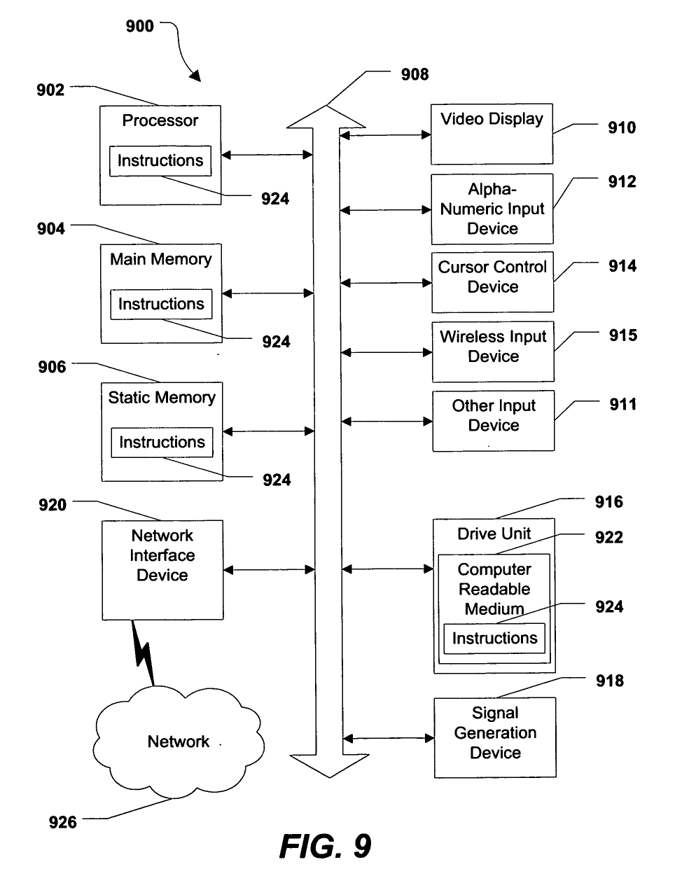

Referring to FIG. 9, an illustrative embodiment of a general computer system is shown and is designated 900. The computer system 900 can include a set of instructions that can be executed to cause the computer system 900 to perform any one or more of the methods or computer based functions disclosed herein. The computer system 900, or any portion thereof, may operate as a standalone device or may be connected, e.g., using a network, to other computer systems or peripheral devices, including a server or set-top box device and associated methods, as shown in FIGS. 1-8.

In a networked deployment, the computer system may operate in the capacity of an IPTV server or set-top box device. The computer system 900 can also be implemented as or incorporated into various devices, such as a personal computer (PC), a tablet PC, a set-top box (STB), a laptop computer, a desktop computer, a control system, or any other machine adapted to executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics-processing unit (GPU), or both. Moreover, the computer system 900 can include a main memory 904 and a static memory 906 that can communicate with each other via a bus 908. As shown, the computer system 900 may further include a video display unit 910, such as a liquid crystal display (LCD), an organic light emitting diode (OLED), a flat panel display, a solid state display, or a cathode ray tube (CRT). Additionally, the computer system 900 may include an input device, such as an alpha-numeric input device 912, a cursor control device 914, a wireless input device 915, such as a remote control device, or any combination thereof. The wireless input device 915 may include a remote control, such as a remote control device utilized by a subscriber to change channels and otherwise control the operation of a set-top box. Such a remote control may include a select button or key to allow a subscriber to select a user-selectable indicator, such as the indicator 324 in FIG. 3. The computer system 900 can also include a disk drive unit 916, a signal generation device 918, such as a speaker or remote control, and a network interface device 920.

In a particular embodiment, as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal, so that a device connected to a network 926 can communicate voice, video or data over the network 926. Further, the instructions 924 may be transmitted or received over the network 926 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
transmitting a video stream to a set-top box, the video stream including a targeted advertisement including a user selectable indicator to identify supplemental video content related to the targeted advertisement based on a subscriber profile associated with the set-top box;
receiving a request from the set-top box based on the user selectable indicator; and
transmitting the supplemental video content to a memory of the set-top box independently from the video stream and without interrupting display of the video stream.

2. The method of claim 1, further comprising:
storing a list element related to the supplemental video content in a digital video recording (DVR) list associated with the set-top box in a memory of a server for later retrieval in response to receiving the request.

3. The method of claim 1, wherein transmitting the supplemental video content comprises transmitting the supplemental video content to the set-top box after transmitting the video stream.

4. The method of claim 1, further comprising:
selecting the targeted advertisement from a plurality of advertisements based on the subscriber profile, where the targeted advertisement includes a target profile that at least partially matches the subscriber profile.

5. The method of claim 1, further comprising:
storing a record of each request associated with the set-top box in a log file.

6. The method of claim 5, further comprising:
modifying the subscriber profile associated with the set-top box according to data stored in the log file.

7. The method of claim 5, further comprising:
receiving an indication from the set-top box each time the supplemental video content is viewed; and
storing the indication in the log file, wherein the indication is associated with the record of the associated request.

8. The method of claim 1, wherein the subscriber profile comprises demographic data and customer usage data associated with the set-top box.

9. The method of claim 1, wherein the subscriber profile comprises customer account information and customer preference data.

10. A system comprising:
selection logic to select a targeted advertisement including a user selectable indicator based on a subscriber profile associated with a set-top box, the user selectable indicator to identify supplemental video content related to the targeted advertisement;
insertion logic to insert the targeted advertisement into a video stream at pre-determined advertising insertion points; and
a transmission interface to transmit the video stream with the targeted advertisement to the set-top box, the transmission interface responsive to a network to receive a selection related to the user selectable indicator and to transmit the supplemental video content to a memory of the set-top box independently of the video stream and without interrupting display of the video stream.

11. The system of claim 10, further comprising:
a memory to store a log related to transmission of the supplemental video content.

12. The system of claim 10, further comprising:
logic to adjust the subscriber profile associated with the set-top box according to the selection.

13. The system of claim 10, wherein the subscriber profile comprises subscriber usage data associated with the set-top box, the subscriber usage data including viewing habits, visited web sites, and demographic data.

14. The system of claim 10, wherein the subscriber profile comprises subscriber account information including a location associated with the subscriber account.

15. The system of claim 10, further comprising
a second memory to store an identifier associated with the supplemental video content in a digital video recorder (DVR) memory of the system.

16. A method comprising:
receiving a video stream including a targeted advertisement having a user selectable indicator at a set-top box device from a network, the user selectable indicator to identify supplemental video content related to the targeted advertisement;
providing the video stream to a display device;
receiving an input related to the user selectable indicator at the set-top box; and
retrieving and storing the supplemental video content in a memory of the set-top box without interrupting the video stream to the display device.

17. The method of claim 16, further comprising:
adding a list element related to the supplemental video content to a list menu including one or more list elements, wherein each list element of the one or more list elements is associated with a particular video stream stored in the memory.

18. The method of claim 17, further comprising:
transmitting the list menu to the display device;
receiving a user selection of the list element at the set-top box;
retrieving the supplemental video content associated with the list element from the memory in response to receiving the user selection; and
transmitting the supplemental video content to the display device.

19. The method of claim 16, further comprising:
receiving, at a later time, a user input to display the supplemental video;
retrieving the supplemental video from the memory in response to receiving the user input; and
providing the supplemental video to the display device.

20. A set-top box comprising:
an interface to receive a video stream including an advertisement having a user selectable indicator, the user selectable indicator to identify supplemental video content related to the advertisement;
an output to provide the video stream to a display device;
an input to receive user selections;
a memory; and
logic responsive to the input to identify a user selection related to the user selectable indicator, to generate a request to a network via the interface in response to identification of the user selection, and to retrieve and store the supplemental video content in the memory without interrupting the video stream to the display device.

21. The set-top box of claim 20, wherein the logic generates a list menu for user selection of the supplemental video content after the supplemental video content is stored.

22. The set-top box of claim 20, wherein the logic is to identify a user selection to access the supplemental video content stored in the memory and to initiate retrieval and display of the supplemental video content from the memory.

23. The set-top box of claim 20, wherein the advertisement comprises a targeted advertisement that is targeted according to a subscriber profile.

24. The set-top box of claim 20, wherein the logic organizes the list menu by date, wherein each list element is stored within the list menu according to a date on which the request associated with the list element is generated.
